(19) United States
(12) Patent Application Publication
(10) Pub. No.: US 2015/0257330 A1
(43) Pub. Date: Sep. 17, 2015

(54) Seed Planting Apparatus

(71) Applicant: Randy P. Remme, Fremont, WI (US)

(72) Inventor: Randy P. Remme, Fremont, WI (US)

(21) Appl. No.: 14/208,753

(22) Filed: Mar. 13, 2014

(51) Int. Cl. A01C 1/04

(52) U.S. Cl. CPC A01C 1/042

(57) ABSTRACT

A seed planting apparatus provides a simplified way of planting seeds. The apparatus includes an elongated tape. A plurality of seeds is couplable to the tape. The seeds extend along a longitudinal axis of the tape when the seeds are coupled to the tape.

### BACKGROUND OF THE DISCLOSURE

### Field of the Disclosure

The disclosure relates to planting apparatuses and more particularly pertains to a new planting apparatus for providing a simplified way of planting seeds.

SUMMARY OF THE DISCLOSURE

An embodiment of the disclosure meets the needs presented above by generally comprising an elongated tape. A plurality of seeds is couplable to the tape. The seeds extend along a longitudinal axis of the tape when the seeds are coupled to the tape.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a seed planting apparatus according to an embodiment of the disclosure.

FIG. 2 is an exploded top front side perspective view of an embodiment of the disclosure.

FIG. 3 is a cross-layeral view of an embodiment of the disclosure taken along line 3-3 of FIG. 1.

FIG. 4 is a top front side perspective view of an embodiment of the disclosure in use.

FIG. 5 is a side view of an embodiment of the disclosure showing one method of constructing the roll of tape.

FIG. 6 is a schematic diagram showing a method of preparing seeds within an area of prepared soil.

### DESCRIPTION OF THE PREFERRED EMBODIMENT

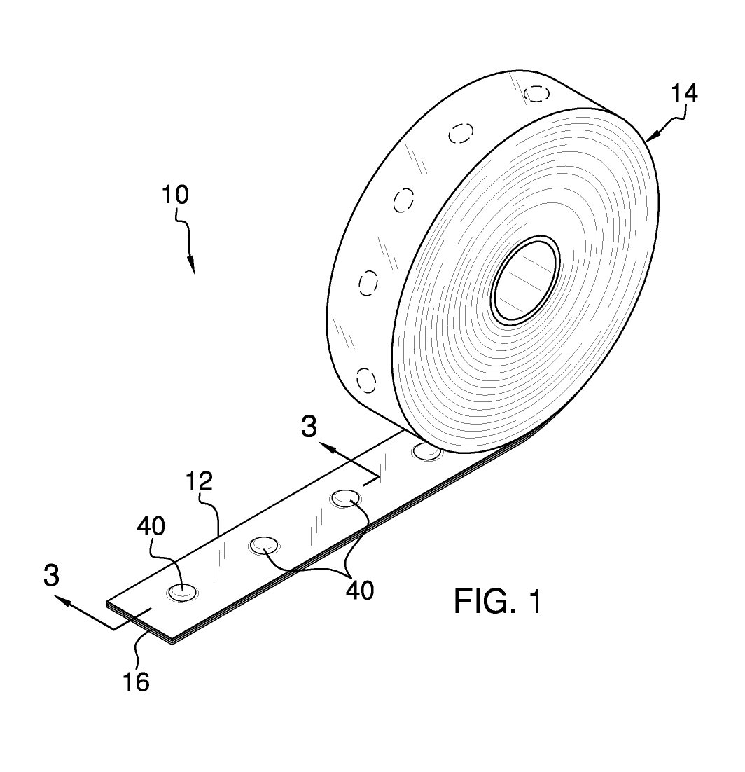

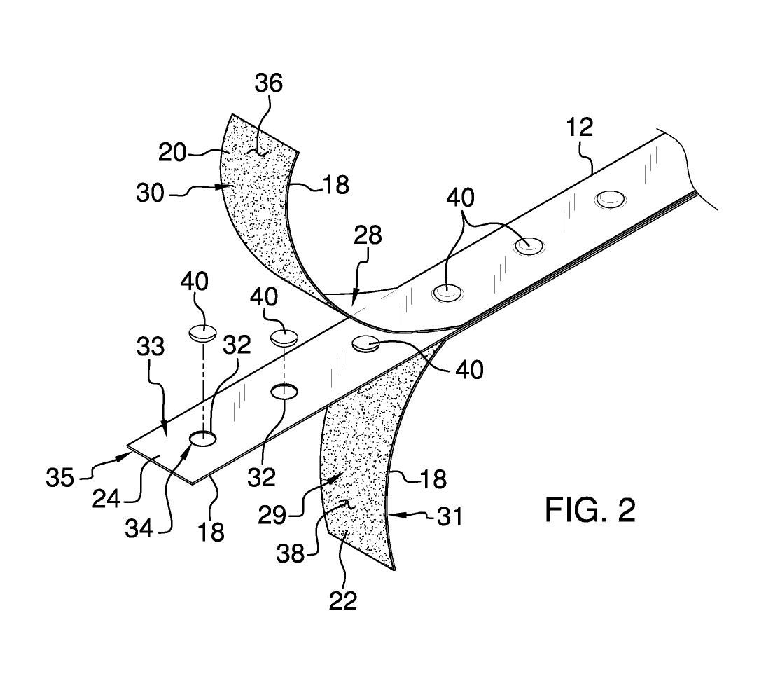

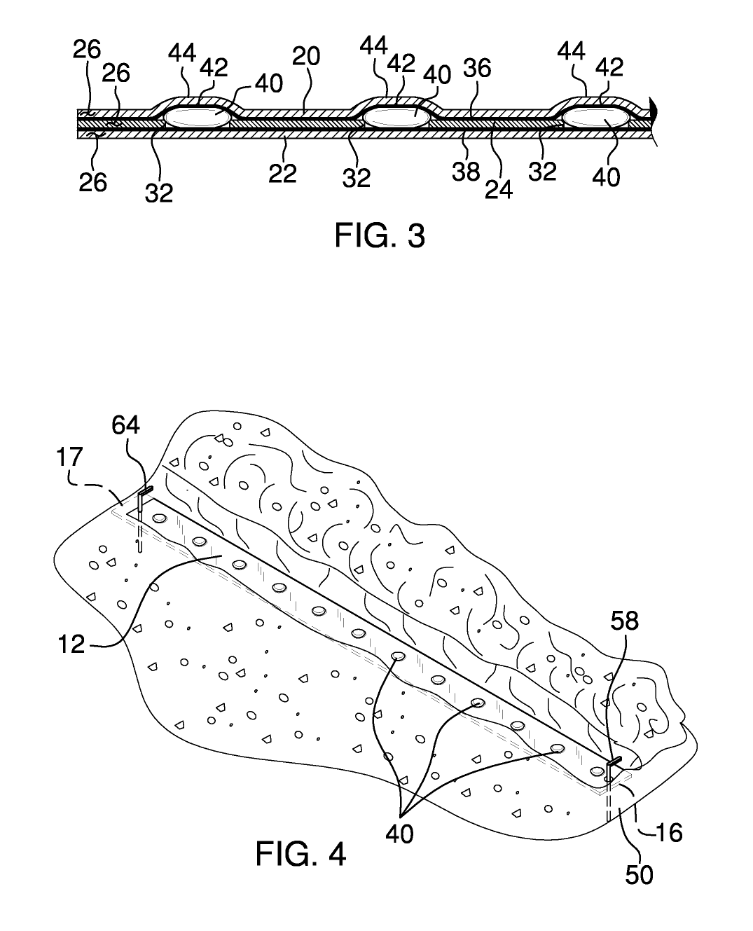

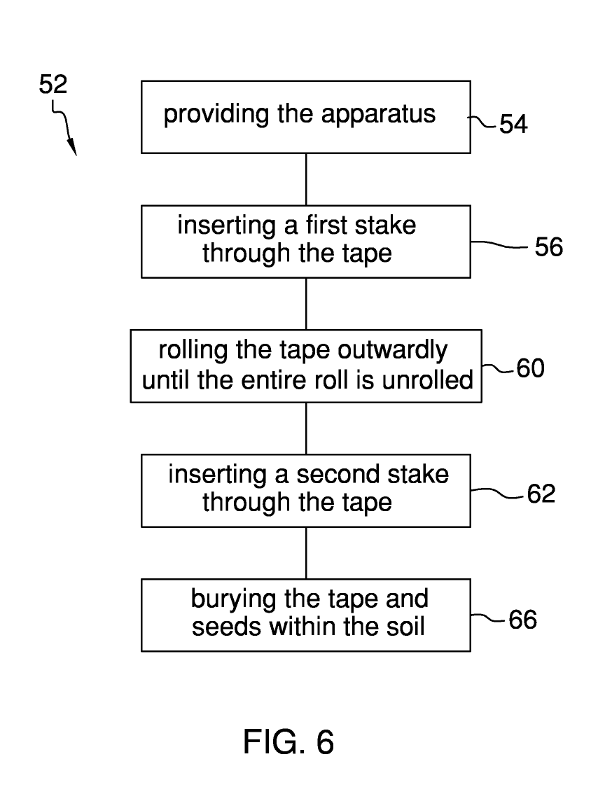

With reference now to the drawings, and in particular to FIGS. 1 through 6 thereof, a new planting apparatus embodying the principles and concepts of an embodiment of the disclosure and generally designated by the reference numeral 10 will be described.

As best illustrated in FIGS. 1 through 6, the seed planting apparatus 10 generally comprises an elongated tape 12. The tape 12 is positionable to form a roll 14. A free end 16 of the tape 12 is extendable outwardly away from the roll 14. The tape 12 includes a plurality of layers 18 including an upper layer 20, a lower layer 22 and a medial layer 24 coupled to and positioned between the upper layer 20 and the lower layer 22. Each of the plurality of layers 18 is comprised of a biodegradable material 26 such as biodegradable paper or the like. The upper layer 20 has a top surface 28 and a bottom surface 30. The lower layer 22 has a top surface 29 and a bottom surface 31. Similarly, the medial layer 24 has a top surface 33 and a bottom surface 35. The medial layer 24 has a plurality of spaced holes 32 positioned therein. The holes 32 are aligned in a row 34 extending along the longitudinal axis of the tape 12. Each of the holes 32 may be evenly spaced from adjacently positioned ones of the holes 32.

A first adhesive 36 is positioned on the bottom surface 30 of the upper layer 20. A second adhesive 38 is positioned on the top surface 29 of the lower layer 22. A plurality of seeds 40 is couplable to the tape 12 using each of the first adhesive 36 and the second adhesive 38. This allows the free end 16 of the tape 12 to be rolled outwardly without causing any seeds 40 to detach from the tape 12. The seeds 40 extend along a longitudinal axis of the tape 12 when the seeds 40 are coupled to the tape 12. Each of the seeds 40 is positionable in an associated one of the holes 32 to help retain the seeds 40 on the tape 12. The holes 32 are sized according to the particular type of seed 40 being planted. In particular, the seeds 40 may have a size and shape such that a top 42 of each of the seeds 40 defines an associated outward projection 44 in the upper layer 20 when the seeds 40 are coupled to the tape 12. Similarly, the holes 32, and thus the seeds 40, are spaced apart according to the particular type of seed 40 being planted, taking into account the expected size of the plant at full maturity and any seed planting specifications. The seeds 40 are completely sealed within their associated areas on the tape 12.

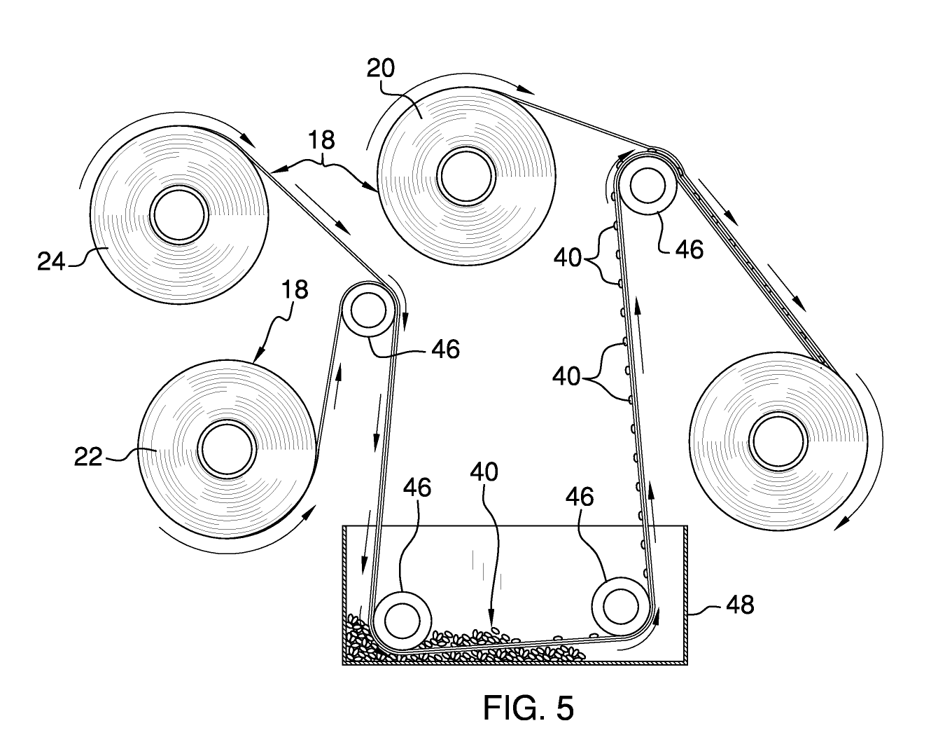

As shown in FIG. 5, one method of constructing the roll 14 is to provide a plurality of cylinders 46. The lower layer 22 and the medial layer 24 are rotated around each of the cylinders 46. The upper layer 20 is rotated around an associated one of the cylinders 46 such that the upper layer 20 is attached to the medial layer 24 only after the second adhesive 38 couples the seeds 40 to the tape 12. A container 48 having a vibrating unit is provided. The seeds 40 are positionable in the container 48. As the container 48 and the seeds 40 vibrate, the second adhesive 38 couples the seeds 40 to the tape 12.

In use, the apparatus 10 provides for a method 52 of planting seeds 40 within an area of prepared soil 50. A first step 54 is providing the apparatus 10 as described above. Another step 56 is inserting a first stake 58 through the tape 12 proximate the free end 16 of the tape 12 to anchor the tape 12 into the area of prepared soil 50. Still another step 60 is rolling the tape 12 outwardly until the entire roll 14 is unrolled, as shown in FIG. 4. A further step 62 is inserting a second stake 64 into the tape 12 proximate the end 17 of the tape 12 opposite the free end 16 of the tape 12 to anchor the tape 12 into the area of prepared soil 50. A final step 66 is burying the tape 12, and thus the seeds 40, within the area of prepared soil 50 in a conventional manner so that the seeds 40 will be allowed to germinate. The biodegradable nature of the tape 12 ensures that the tape 12 will not interfere with growth of the seeds 40. In this manner, the apparatus 10 allows a person to quickly and easily plant rows 34 of seeds 40 instead of having to plant each seed 40 individually.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A seed planting apparatus comprising:
an elongated tape; and
a plurality of seeds being couplable to said tape, said seeds extending along a longitudinal axis of said tape when said seeds are coupled to said tape.

2. The apparatus of claim 1, further comprising said tape including a plurality of layers.

3. The apparatus of claim 2, wherein said plurality of layers includes an upper layer, a lower layer and a medial layer coupled to and positioned between said upper layer and said lower layer.

4. The apparatus of claim 3, further comprising said medial layer having a plurality of spaced holes positioned therein, each of said seeds being positionable in an associated one of said holes.

5. The apparatus of claim 4, further comprising said holes being aligned in a row extending along said longitudinal axis of said tape.

6. The apparatus of claim 3, further comprising:
each of said plurality of layers having a top surface and a bottom surface; and
a first adhesive positioned on said bottom surface of said upper layer.

7. The apparatus of claim 6, further comprising a second adhesive positioned on said top surface of said lower layer.

8. The apparatus of claim 3, further comprising each of said plurality of layers being comprised of a biodegradable material.

9. The apparatus of claim 1, further comprising said tape being positionable to form a roll, a free end of said tape being extendable outwardly away from said roll.

10. The apparatus of claim 4, further comprising each of said holes being evenly spaced from adjacently positioned ones of said holes.

11. The apparatus of claim 4, further comprising said seeds having a size and shape such that a top of each of said seeds defines an associated outward projection in said upper layer when said seeds are coupled to said tape.

12. A seed planting apparatus comprising:
an elongated tape, said tape being positionable to form a roll, a free end of said tape being extendable outwardly away from said roll, said tape including a plurality of layers, said plurality of layers including an upper layer, a lower layer and a medial layer coupled to and positioned between said upper layer and said lower layer, each of said plurality of layers being comprised of a biodegradable material, each of said plurality of layers having a top surface and a bottom surface, said medial layer having a plurality of spaced holes positioned therein, said holes being aligned in a row extending along said longitudinal axis of said tape, each of said holes being evenly spaced from adjacently positioned ones of said holes;
a first adhesive positioned on said bottom surface of said upper layer;
a second adhesive positioned on said top surface of said lower layer; and
a plurality of seeds being couplable to said tape, said seeds extending along a longitudinal axis of said tape when said seeds are coupled to said tape, each of said seeds being positionable in an associated one of said holes, said seeds having a size and shape such that a top of each of said seeds defines an associated outward projection in said upper layer when said seeds are coupled to said tape.

13. A method of planting seeds within an area of prepared soil, the steps of the method comprising:
providing an elongated tape and a plurality of seeds coupled to said tape, said seeds extending along a longitudinal axis of said tape, said tape being positionable to form a roll;
inserting a first stake through said tape proximate a free end of said tape to anchor said tape into an area of prepared soil;
rolling said tape outwardly such that an entirety of said roll is unrolled;
inserting a second stake through said tape proximate an end of said tape opposite said free end of said tape to anchor said tape into said area of prepared soil; and
burying said tape within said area of prepared soil.
